(19) United States
(12) Patent Application Publication
(10) Pub. No.: US 2026/0104973 A1
(43) Pub. Date: Apr. 16, 2026

(54) MULTI-CLUSTER APPLICATION FAILURE MIGRATION METHOD AND SYSTEM SUPPORTING MULTIPLE TENANTS

(71) Applicants: CHINA ACADEMY OF RAILWAY SCIENCES CORPORATION LIMITED, Beijing (CN); INSTITUTE OF COMPUTING TECHNOLOGIES, CHINA ACADEMY OF RAILWAY SCIENCES CORPORATION LIMITED, Beijing (CN); BEIJING JINGWEI INFORMATION TECHNOLOGIES LIMITED COMPANY, Beijing (CN)

(72) Inventors: Zhe WANG, Beijing (CN); Ge GUO, Beijing (CN); Chengliang LIU, Beijing (CN); Weiqiao ZHU, Beijing (CN); Minggang LI, Beijing (CN); Weijun HAO, Beijing (CN); Weimeng WANG, Beijing (CN)

(21) Appl. No.: 19/420,415

(22) Filed: Dec. 15, 2025

Related U.S. Application Data
(63) Continuation of application No. PCT/CN2025/113102, filed on Aug. 6, 2025.

(30) Foreign Application Priority Data
Aug. 19, 2024 (CN) 202411132256.8

(51) Int. Cl. G06F 11/20; G06F 11/16

(52) U.S. Cl. CPC G06F 11/203; G06F 11/1658; G06F 2201/805

(57) ABSTRACT

The present application discloses a multi-cluster application failure migration method and system supporting multiple tenants, and relates to the field of cluster application failure migration technologies. The method includes: creating a multi-cluster environment by using kubernetes application software; for each worker cluster in the multi-cluster environment, creating the tenants in the worker cluster; for each tenant, deploying an application in the tenant and configuring a failure migration strategy associated with the application; generating a resource quota information table according to the failure migration strategy and state information of the worker cluster; and generating a failure migration solution according to the resource quota information table, for providing a technical guidance after a certain worker cluster fails, so as to facilitate the tenants, the applications and components in the failed worker cluster which can be migrated to be migrated to other non-failed worker clusters and redeployed.

### CROSS-REFERENCE TO RELATED APPLICATIONS

This application is a continuation of International Application No. PCT/CN2025/113102, filed on Aug. 6, 2025, which claims priority to Chinese Patent Application No. CN202411132256.8, filed on Aug. 19, 2024, all of which are hereby incorporated by reference in their entireties.

### TECHNICAL FIELD

The present application relates to the field of cluster application failure migration technologies, and in particular, to a multi-cluster application failure migration method and system supporting multiple tenants.

### BACKGROUND

With the increasing popularity of containerized applications, most enterprises employ kubernetes (an open-source container orchestration engine from Google) as a container orchestration tool to support the operation of containers. Although the high availability of kubernetes clusters can guarantee the reliability of applications on the clusters to some extent, it is still impossible to avoid single cluster failures due to network failures or host failures. Therefore, in order to enable enterprise applications to stably provide external services under any conditions, a solution for application failure migration in case of a single kubernetes cluster failures needs to be realized to improve the reliability of the applications.

Currently, multiple kubernetes clusters are generally adopted to form multiple clusters, and when a certain cluster fails, applications running on the failed cluster can be migrated to other healthy clusters. However, this method has the following problems.
(1) Point-to-point migration is performed. Only migration from a cluster A to a cluster B is supported, flexible adjustments cannot be realized, and strategies are needed to be reconfigured for each adjustment.
(2) Per-tenant migration is not supported. In existing cluster failure migration solutions, overall cluster migration or single application failure migration is performed, wherein the concept of tenants is not involved, and measurement of tenant resources is not utilized.
(3) One solution is provided for one case, and reusing is not supported. Cluster failure migration configuration is performed after the cluster failure occurs, the strategies of the cluster failure migration configuration need to be readjusted to adapt to a new cluster environment along with changes of the cluster environment, and flexibility is poor.
(4) The configuration is complicated. In order to realize control over the failure migration process, many parameters need to be configured by the user, which increases the use difficulty and threshold of the user and does not facilitate the implementation of a holistic strategy.
(5) There is a lot of resource waste. Under the condition that many of the existing kubernetes clusters in the enterprises are in relatively full load operation, each cluster has scattered resources which cannot be effectively utilized; in order to satisfy application failure overall migration, a new backup cluster needs to be built to accommodate the application to be migrated, which causes a lot of resource waste and increases enterprise costs.

In summary, how to provide a multi-cluster application failure migration method which realizes flexible adjustments, supports per-tenant migration and reusing, realizes simple configurations and has a high resource utilization rate is a technical problem to be solved urgently in the art.

### SUMMARY

An objective of the present application is to provide a multi-cluster application failure migration method and system supporting multiple tenants, which not only support per-tenant migration and reusing, but also improve adjustment flexibility, reduce configuration complexity and improve a resource utilization rate.

In order to achieve the above objective, the present application provides the following solutions.

In a first aspect, the present application provides a multi-cluster application failure migration method supporting multiple tenants, including:
creating a multi-cluster environment by using kubernetes application software; wherein the multi-cluster environment includes a management cluster and a plurality of worker clusters, the management cluster is configured to manage each worker cluster, and the worker clusters are configured to deploy the tenants;
for each worker cluster in the multi-cluster environment, creating the tenants in the worker cluster; wherein each worker cluster includes a plurality of tenants, and the tenants are used for resource isolation in a single worker cluster scenario and resource isolation across clusters in a multi-worker cluster scenario;
for each tenant, deploying an application in the tenant and configuring a failure migration strategy associated with the application; wherein the application includes a plurality of components, the failure migration strategy includes tenant information and application information, the application information includes an application weight and application topology, the application weight is used for representing a priority of the application during failure migration, and the application topology includes a maximum replicate number and a minimum replicate number of each component in the application after failure migration;
generating a resource quota information table according to the failure migration strategy and state information of the worker cluster; wherein the state information of the worker cluster includes application deployment information of each tenant in the worker cluster, application resource occupation information and worker-cluster overall resource occupation information, and the resource quota information table includes total resource information of each worker cluster, resource occupation information of each tenant, a maximum resource utilization value, an average resource occupation value and a worker cluster state; and
generating a failure migration solution according to the resource quota information table; wherein the failure migration solution is used for providing a technical guidance after a certain worker cluster fails, so as to facilitate the tenants, the applications and the components in the failed worker cluster which can be migrated to be migrated to other non-failed worker clusters and redeployed.

Optionally, a multi-cluster state collection module, a failure migration scheduling module, and a tenant management module are arranged in the management cluster.

The multi-cluster state collection module is configured to configure an access authorization certificate of each worker cluster in the management cluster, and acquire the state information and the resource information of each worker cluster through APIServer of each worker cluster.

The failure migration scheduling module is configured to acquire the state information and the resource information of each worker cluster from the multi-cluster state collection module, generate the failure migration solution in real time according to the failure migration strategy and execute failure migration of the application.

The tenant management module is configured to manage the tenant information in each worker cluster.

Optionally, for each worker cluster in the multi-cluster environment, creating the tenants in the worker cluster specifically includes:
creating the corresponding tenant in each worker cluster according to tenant configuration information; the tenant configuration information including name of the tenant, a total resource quota and a sub-quota, the total resource quota representing a total CPU quota, a total memory quota and a total storage quota occupied by the tenant in the whole multi-cluster environment, and the sub-quota representing a CPU quota, a memory quota and a storage quota occupied by the tenant in each worker cluster; and
generating an identification code for each tenant, the identification code being used for identifying identity information of the tenant.

Optionally, the identification code is a UUID.

Optionally, for each tenant, deploying an application in the tenant and configuring a failure migration strategy associated with the application specifically includes:
deploying the application for each tenant by adopting an automatic deployment tool to obtain the tenant information and the application information corresponding to each tenant; and
determining the failure migration strategy according to the tenant information and the application information corresponding to each tenant.

Optionally, the automatic deployment tool is Argocd.

Optionally, generating a failure migration solution according to the resource quota information table specifically includes:
generating a preliminary failure migration solution according to the resource quota information table; and
optimizing the preliminary failure migration solution to obtain an optimized failure migration solution; optimized failure migration solution being used as the finally generated failure migration solution.

Optionally, the optimizing the preliminary failure migration solution to obtain an optimized failure migration solution specifically includes:
determining the application with the minimum application weight from all the applications of the tenant meeting a migration condition according to the application weights corresponding to respective applications;
for components in the application with the minimum application weight, when the maximum replicate number of a component is greater than 1, reducing a replicate number of the component by 1 from the preliminary failure migration solution; in order of application priority from low to high, reducing the reducible replicate numbers of all the components in other applications of the current tenant that already meet the migration condition in this replicate number reduction mode until the component which does not meet the migration condition is incorporated into the preliminary failure migration solution; and
when the application and the component thereof which do not meet the migration condition still exist after all the reducible replicate numbers are reduced completely, marking the application and the component thereof which do not meet the migration condition as a type which cannot be migrated, and deleting other components of this application meeting the migration condition from the preliminary failure migration solution to obtain the optimized failure migration solution.

Optionally, after the step of optimizing the preliminary failure migration solution to obtain an optimized failure migration solution, the multi-cluster application failure migration method supporting multiple tenants further includes:
after a certain worker cluster fails, performing failure migration on the tenants, the applications and the components in the failed worker cluster which can be migrated according to the optimized failure migration solution, and generating a failure migration report; wherein the failure migration report includes migration-in worker cluster information and migration-out worker cluster information of the successfully migrated applications for each tenant in the failed worker cluster, and names and the components of the applications which cannot be migrated.

In a second aspect, the present application provides a multi-cluster application failure migration system supporting multiple tenants, including: a memory, a processor and a computer program stored on the memory and capable of running on the processor, wherein the processor executes the computer program to implement the multi-cluster application failure migration method supporting multiple tenants in the first aspect.

According to specific embodiments of the present application, the present application achieves the following technical effects.

The present application provides the multi-cluster application failure migration method and system supporting multiple tenants, and by establishing the multi-cluster environment, deploying the applications for the tenant, and configuring the failure migration strategy associated with the applications, the resource quota information table can be generated according to the failure migration strategy and the state information of the worker cluster, and then, the failure migration solution can be automatically generated according to the resource quota information table, and after a certain worker cluster fails, the tenants, the applications and the components in the failed worker cluster which can be migrated can be migrated and redeployed to other normal worker clusters according to the failure migration solution, so that per-tenant migration and reusing are supported, and the resource quota information table and the failure migration solution can be flexibly adjusted according to the failure migration strategy and the state information of the worker cluster, thereby effectively improving the adjustment flexibility and reducing the configuration complexity. The tenants, the applications and the components thereof can automatically implement failure migration in the multi-cluster environment, so that a service stopping time can be reduced to the maximum extent, and then, the resource utilization rate is effectively improved.

### BRIEF DESCRIPTION OF THE DRAWINGS

In order to illustrate the technical solutions in the embodiments of the present application or the prior art more clearly, the drawings required in the embodiments will be described briefly. Apparently, the following described drawings are merely for some embodiments of the present application, and other drawings can be derived from these drawings by those of ordinary skill in the art without any creative effort.

FIG. 1 is a schematic flow chart of a multi-cluster application failure migration method supporting multiple tenants according to an embodiment of the present application.

FIG. 2 is a diagram of a multi-cluster architecture in an embodiment of the present application.

FIG. 3 is a view of a relationship between the tenants and multiple clusters in an embodiment of the present application.

FIG. 4 is a diagram of configuration parameters of a migration strategy of applications in a tenant in an embodiment of the present application.

FIG. 5 is a view of a relationship between a tenant and a total amount of application resources in an embodiment of the present application.

FIG. 6 is a schematic diagram of overall failure migration for a tenant in an embodiment of the present application.

FIG. 7 is a view of a relationship between an application and a total amount of component resources in an embodiment of the present application.

FIG. 8 is a schematic diagram of overall migration of the applications within a tenant in an embodiment of the present application.

FIG. 9 is a schematic diagram of completion of application migration by component in an embodiment of the present application.

FIG. 10 is a schematic structural diagram of a multi-cluster application failure migration system supporting multiple tenants according to an embodiment of the present application.

### DETAILED DESCRIPTION

The technical solutions in the embodiments of the present application are clearly and completely described with reference to the accompanying drawings in the embodiments of the present application, and apparently, the described embodiments are not all but only a part of the embodiments of the present application. All other embodiments obtained by a person of ordinary skill in the art based on the embodiments of the present application without creative efforts shall fall within the protection scope of the present application.

In order to make the aforementioned objects, features and advantages of the present application more apparent, the present application is described below in further detail with reference to the accompanying drawings and specific embodiments.

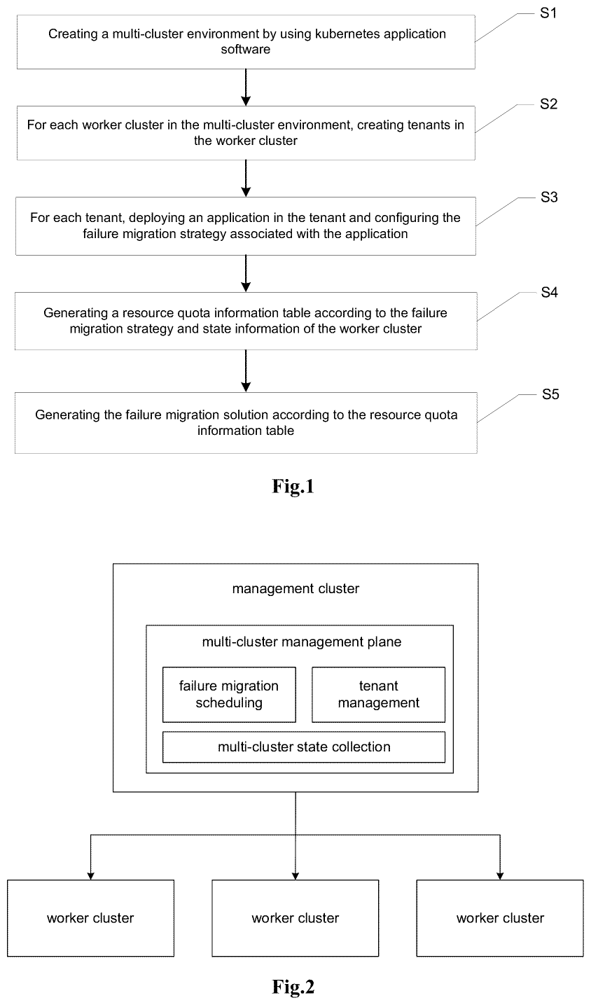

As shown in FIG. 1, the present embodiment provides a multi-cluster application failure migration method supporting multiple tenants. The method includes the following steps:

step S1: creating a multi-cluster environment by using kubernetes application software.

In the present embodiment, the multi-cluster environment includes a management cluster and a plurality of worker clusters, the management cluster is configured to manage each worker cluster, or the like, and the worker clusters are configured to deploy the tenants, or the like.

In the present embodiment, a multi-cluster state collection module, a failure migration scheduling module, and a tenant management module are arranged in the management cluster.

The multi-cluster state collection module is mainly configured to configure an access authorization certificate of each worker cluster in the management cluster, and acquire state information, resource information, or the like, of each worker cluster through APIServer of each worker cluster.

The failure migration scheduling module is mainly configured to acquire the state information and the resource information of each worker cluster from the multi-cluster state collection module, generate a failure migration solution in real time according to a failure migration strategy and execute failure migration of the application, or the like.

The tenant management module is mainly configured to manage tenant information in each worker cluster, or the like.

Step S2: for each worker cluster in the multi-cluster environment, creating the tenants in the worker cluster.

In the present embodiment, each worker cluster includes a plurality of tenants, and the tenants are used for resource isolation in a single worker cluster scenario and resource isolation across clusters in a multi-worker cluster scenario.

In the present embodiment, the step S2 of for each worker cluster in the multi-cluster environment, creating the tenants in the worker cluster specifically includes:
step S21: creating corresponding tenant in each worker cluster according to tenant configuration information; the tenant configuration information including name of the tenant, a total resource quota and a sub-quota, the total resource quota representing a total CPU quota, a total memory quota and a total storage quota occupied by the tenant in the whole multi-cluster environment, and the sub-quota representing a CPU quota, a memory quota and a storage quota occupied by the tenant in each worker cluster; and
step S22: after the tenant is created, generating an identification code for the tenant, the identification code being used for identifying identity information of the tenant. The identification code may be a UUID (universally unique identifier) or other types of identification codes.

Step S3: for each tenant, deploying an application in the tenant and configuring the failure migration strategy associated with the application.

In the present embodiment, the application includes a plurality of components, the failure migration strategy includes the tenant information and application information, the application information includes an application weight and application topology, the application weight is used for representing a priority of the application during failure migration, and the application topology includes a maximum replicate number and a minimum replicate number of each component in the application after failure migration. In the present embodiment, the step S3 of for each tenant, deploying an application in the tenant and configuring the failure migration strategy associated with the application specifically includes:
step S31: deploying the application for each tenant by adopting an automatic deployment tool to obtain the tenant information and the application information corresponding to each tenant. The automatic deployment tool may be Argocd or other automatic deployment tools.
Step S32: determining the failure migration strategy according to the tenant information and the application information corresponding to each tenant.

Step S4: generating a resource quota information table according to the failure migration strategy and the state information of the worker cluster.

In the present embodiment, the state information of the worker cluster includes application deployment information of each tenant in the worker cluster, application resource occupation information and worker-cluster overall resource occupation information, and the resource quota information table includes total resource information of each worker cluster, resource occupation information of each tenant, a maximum resource utilization value, an average resource occupation value and a worker cluster state.

Step S5: generating the failure migration solution according to the resource quota information table.

In the present embodiment, the failure migration solution may be used for providing a technical guidance after a certain worker cluster fails, so as to facilitate the tenants, the applications and the components in the failed worker cluster which can be migrated to be migrated to other non-failed worker clusters and redeployed.

In the present embodiment, the step S5 of generating the failure migration solution according to the resource quota information table specifically includes:
step S51: generating a preliminary failure migration solution according to the resource quota information table.
Step S52: optimizing the preliminary failure migration solution to obtain an optimized failure migration solution. Due to the limitation of a tenant resource quota, the created preliminary failure migration solution may not satisfy failure migration of all the applications and components, so that the preliminary failure migration solution needs to be optimized in the present embodiment, and the failure migration of as many applications or components as possible can be satisfied after the preliminary failure migration solution is optimized, thereby greatly improving a resource utilization rate. The optimized failure migration solution is used as the finally generated failure migration solution.

In the present embodiment, the step S52 of optimizing the preliminary failure migration solution to obtain an optimized failure migration solution specifically includes:
step S521: determining the application with the minimum application weight from all the applications of the tenant meeting a migration condition according to the application weights corresponding to respective applications;
step S522: for components in the application with the minimum application weight, when the maximum replicate number of a certain component is greater than 1, reducing a replicate number of the component by 1 from the preliminary failure migration solution; in order of application priority from low to high, reducing the reducible replicate numbers of all the components in other applications of the current tenant that already meet the migration condition in this replicate number reduction mode, until the component which does not meet the migration condition is incorporated into the preliminary failure migration solution; and
step S523: when the application and the component thereof which do not meet the migration condition still exist after all the reducible replicate numbers are reduced completely, marking the application and the component thereof which do not meet the migration condition as a type which cannot be migrated, and deleting other components of this application meeting the migration condition from the preliminary failure migration solution to obtain the optimized failure migration solution.

In the present embodiment, after the step S52 of optimizing the preliminary failure migration solution to obtain an optimized failure migration solution, the multi-cluster application failure migration method supporting multiple tenants further includes the following step:
step S53: after a certain worker cluster fails, performing failure migration on the tenants, the applications and the components in the failed worker cluster which can be migrated according to the optimized failure migration solution, and generating a failure migration report. The failure migration report includes migration-in worker cluster information and migration-out worker cluster information of the successfully migrated applications for each tenant in the failed worker cluster, and names and the components of the applications which cannot be migrated.

When put into practical application, a specific operation process of the multi-cluster application failure migration method supporting multiple tenants according to the present embodiment is as follows:

step (1): creating a multi-cluster environment.

In the present embodiment, first, a multi-cluster environment can be formed by multiple kubernetes environments, the multi-cluster environment refers to an environment with multiple clusters, the clusters are divided into two types: management clusters and worker clusters, and usually, there is one management cluster and several worker clusters, as shown in FIG. 2. One cluster (having 3 masters and 1-2 nodes) is selected as the management cluster, and other clusters are selected as the worker clusters. Kubernetes is abbreviated as k8s, and k8s is an abbreviation formed by replacing 8 characters “ubernete” in the middle of the name with the number “8”. It is an open-source application for managing containerized applications on multiple hosts in a cloud platform. The goal of kubernetes is to make deployment of the containerized applications simple and efficient, and kubernetes provides a mechanism for application deployment, planning, updating, and maintenance.

In the present embodiment, the following modules need to be deployed in the management cluster: a multi-cluster state collection module, a failure migration scheduling module and a tenant management module. The above three modules form a multi-cluster management plane as a whole, a multi-cluster architecture is shown in FIG. 2, and main functions of each module are as follows.
1) The multi-cluster state collection module is mainly configured to configure an access authorization certificate of each worker cluster in the management cluster, the module can acquire state and resource information of the worker clusters through each worker cluster, and this module runs in the management cluster as a containerized application. APIServer is a central API coordinator in the k8s cluster and acts as a brain and an entry point of the cluster. APIServer is responsible for receiving and processing API requests from users, controllers and other components, and executing these requests in the cluster.
2) The failure migration scheduling module is mainly configured to acquire state information and resource information of each worker cluster from the multi-cluster state collection module, generate a scheduling strategy in real time according to a failure migration strategy configured by the user and execute failure migration of the application; this module runs in the management cluster as a containerized application.
3) The tenant management module is mainly configured to manage tenant information of each worker cluster, or the like.

In the present embodiment, bringing the worker clusters under the management of the management cluster needs to perform the following two operations: importing kubeconfig files of the worker clusters into a file directory specified by the management cluster to serve as identity bases when the multi-cluster state collection module reads the information of the worker clusters; and configuring an IP address and a port number of APIServer of each worker cluster in the multi-cluster state collection module of the management cluster, the multi-cluster state collection module acquiring the information of the worker cluster through the IP address and the port.

Step (2): creating a cross-cluster tenant in the multi-cluster environment.

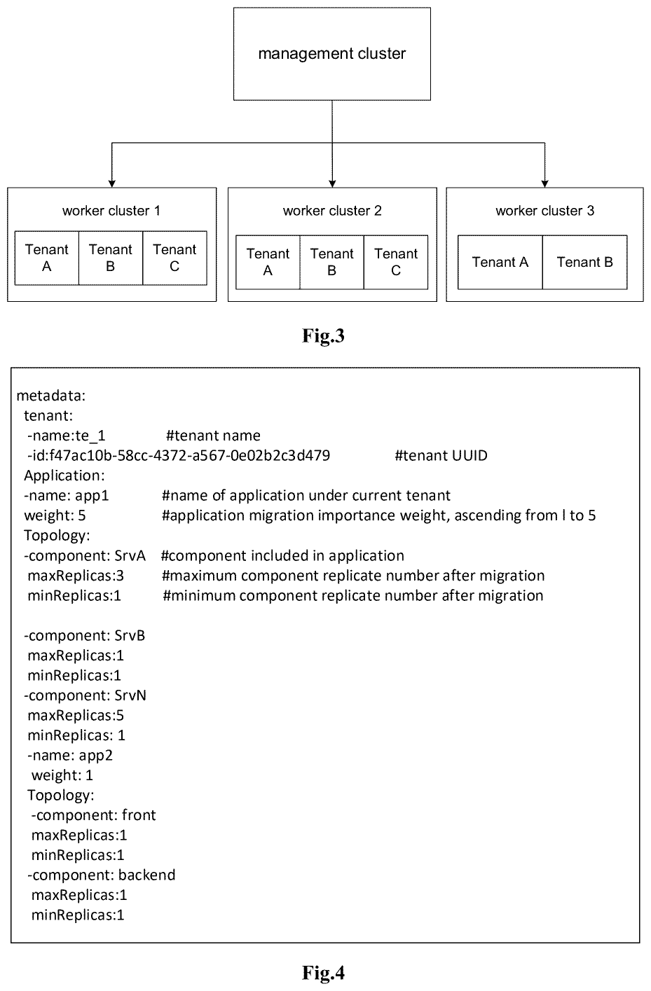

In the present embodiment, in a single cluster scenario, resources in the worker cluster are divided based on tenants, and the tenants are used for resource isolation in the cluster. In a multi-cluster scenario, the tenants are used for resource isolation across clusters, that is, one tenant can occupy resources on multiple clusters, and the sum of the resources occupied by the tenant on the worker clusters is a total resource quota of the tenant. Several users can be created in the tenant, and the user with a tenant resource management capability is called a tenant administrator. In the management cluster, a kubernetes administrator submits tenant configuration information in the multi-cluster environment to a tenant management module, and the tenant configuration information is used for creating the tenant. The tenant configuration information includes a tenant name, a total resource quota, a sub-quota, or the like. The total resource quota represents a total CPU quota, a total memory quota and a total storage quota occupied by the tenant in the whole multi-cluster environment. The sub-quotas indicate CPU quotas, memory quotas and storage quotas occupied by the tenant on respective worker clusters (which may be all worker clusters or some worker clusters). The sum of the sub-quotas on the worker clusters should be less than or equal to the total quota. A relationship between the tenant and the multiple clusters is shown in FIG. 3.

In the present embodiment, after the tenant is created, the tenant management module generates a UUID to represent the tenant, creates a cluster user in all the worker clusters related to the tenant, and associates the UUID to represent the tenant administrator in the worker cluster. The UUID is an industry standard used in a computer system for ensuring high uniqueness of information, and usually, the UUID can be generated by corresponding functions or methods provided by a platform and a programming language, so as to cause all elements in a distributed system to have unique identification information without requiring specification of the identification information by a central control terminal.

Step (3): deploying an application in the tenant.

In the present embodiment, an application is logical integration of multiple components, and each component is a container mirror image, and can be deployed on kubernetes. A containerized application is formed by one or more components, and each component is a containerized mirror image. The application can be deployed in any of the worker clusters, and the deployment mode and script are consistent with those of deployment of services in kubernetes. A deployment script, a service script, a configmap script, or the like, of kubernetes need to be written for each application, the scripts have to contain a size of resources required by the application component, and the tenant administrator of the worker cluster created in the step (2) implements the deployment of the application on a single worker cluster through an automatic deployment tool (such as Argocd). After the deployment is successful, the application occupies a certain resource quota, and at this point, a remaining available resource quota of the tenant should be equal to a current available resource quota minus the resource quota occupied by the application.

Step (4): configuring a failure migration strategy associated with the application in the tenant.

In the present embodiment, after the application deployment is completed, the kubernetes administrator of the management cluster submits the basic failure migration strategy of all the applications of each tenant to a failure migration module. The failure migration strategy mainly includes tenant information and application information, and a strategy configuration parameter file is shown in FIG. 4. The tenant information includes a tenant name, a tenant ID, or the like. The application information includes an application weight, application topology, or the like, the application weight represents a priority of the application during failure migration, and unlisted applications are configured according to a lowest priority 1 by default. The application topology includes a maximum replicate number and a minimum replicate number of each component in the application after the failure migration, and unlisted components are configured according to the maximum replicate number 1 and the minimum replicate number 1 by default.

It should be noted that the kubernetes administrator is different from the tenant administrator, and the kubernetes administrator, i.e., system administrator, refers to a user with highest authority in the kubernetes cluster and is responsible for management of the kubernetes cluster; and the tenant administrator refers to a user with management authority in the tenant, and is responsible for management of the resources in the tenant.

Step (5): generating and maintaining, by the management cluster, a resource quota information table in real time according to the state information and the failure migration strategy of the current worker cluster.

In the present embodiment, multiple tenants may exist in the multi-cluster environment, and the resource of each tenant may span multiple clusters. The multi-cluster state collection module in the multi-cluster management plane regularly refreshes the state of the worker cluster, for example, every 15 s, and reads the state information of the worker cluster through an APIServer interface of the worker cluster. The state information includes the deployment status of the application under each tenant of the current worker cluster, application resource occupation information and a current-cluster overall resource occupation status. Therefore, the multi-cluster state collection module may generate the resource quota information table according to the information, such as the state of each worker cluster and the resource quota of the tenant, as shown in table 1, two worker clusters, i.e., worker cluster 1 and worker cluster 2, are taken as an example for illustration in table 1, and actually, more worker clusters may be included.

TABLE 1
Resource quota information table

| | | | | | | Average | |
|---|---|---|---|---|---|---|---|
| | | | | | Maximum | resource | |
| | Total | | | | resource | occupation | Cluster |
| | resource | Tenant A | Tenant B | Tenant N | use value | value | State |
| worker | CPU: | CPU: | CPU: | CPU: | CPU: | CPU: | Normal |
| cluster | 200 | 50 | 20 | 30 | 100 | 40 | working |
| 1 | Memory: | Memory: | Memory: | Memory: | Memory: | Memory: | |
| | 150 GB | 30 GB | 10 GB | 30 GB | 80 GB | 60 GB | |
| | Storage: | Storage: | Storage: | Storage: | Storage: | Storage: | |
| | 5 TB | 1 TB | 300 GB | 600 GB | 2 TB | 600 GB | |
| worker | CPU: | CPU: | CPU: | CPU: | CPU: | CPU: | Normal |
| cluster | 200 | 30 | 40 | 60 | 130 | 350 | working |
| 2 | Memory: | Memory: | Memory: | Memory: | Memory: | Memory: | |
| | 200 GB | 15 GB | 40 GB | 70 GB | 120 GB | 40 GB | |
| | Storage: | Storage: | Storage: | Storage: | Storage: | Storage: | |
| | 5 TB | 500 GB | 800 GB | 1 TB | 2 TB | 300 GB | |

Step (6): once the management cluster senses a failure of the worker cluster, generating a failure migration solution of the application according to the resource quota information table.

In the present embodiment, when one worker cluster cannot be communicated with the multi-cluster management plane for two consecutive refresh cycles, the state of the worker cluster is marked as “abnormal”. After a certain worker cluster is marked as “abnormal”, the multi-cluster management plane initiates failure migration of the applications in the worker cluster. In the present embodiment, the refresh cycle may be set to 30 s.

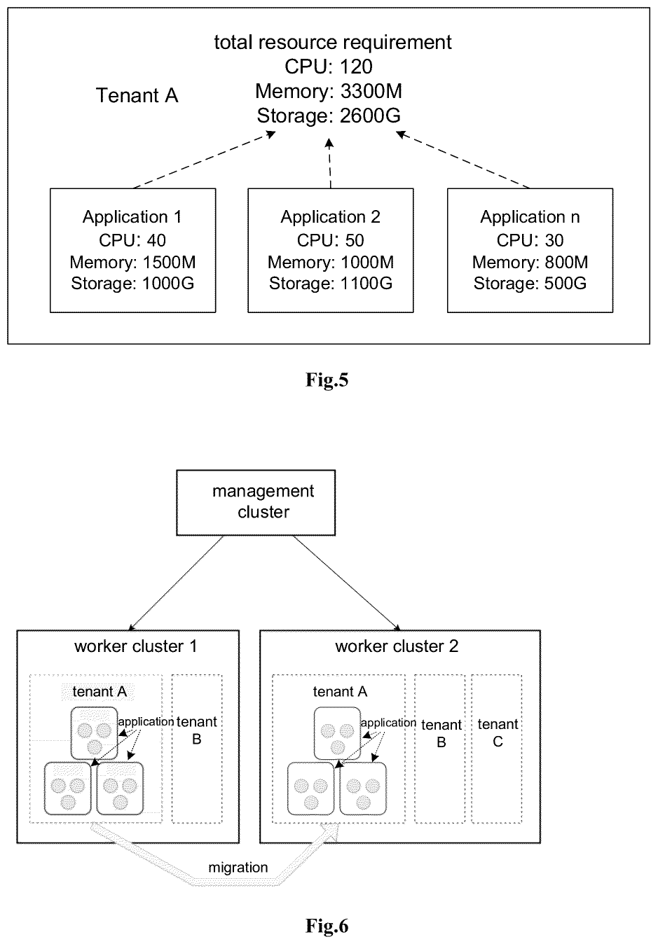

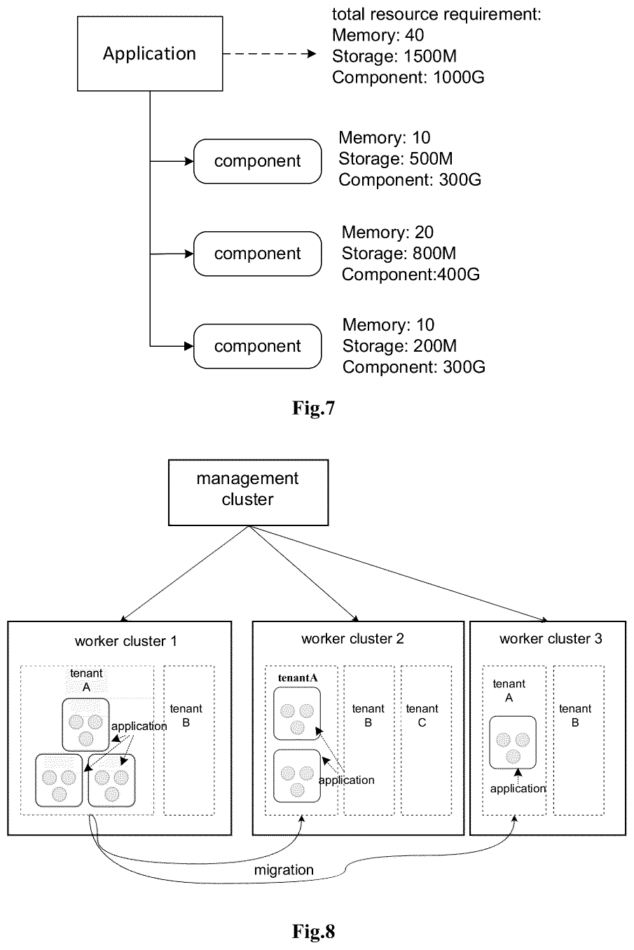

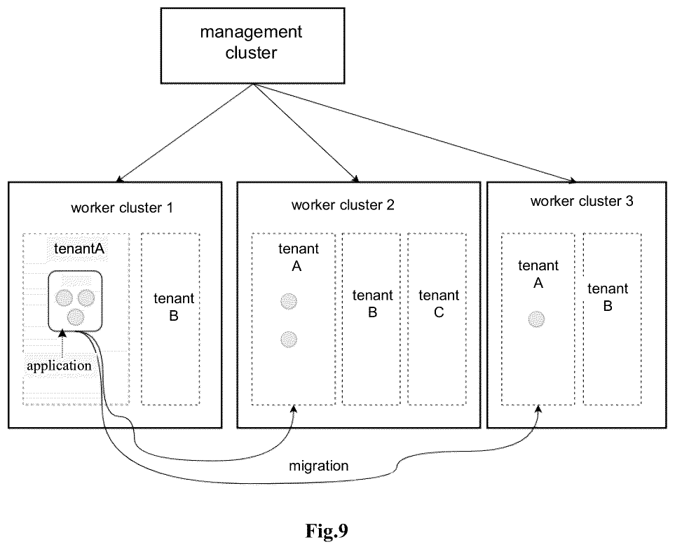

In the present embodiment, when the multi-cluster management plane of the management cluster senses that a certain worker cluster is in an abnormal state, such as connection interruption, the information of the worker cluster being unreachable, or the like, the failure migration scheduling module may automatically create the failure migration solution according to the current resource quota information table (i.e., table 1) and the deployment information of the applications in each worker cluster. The creation process of the failure migration solution includes the following content.
1) The failed worker cluster can be referred to as a failed cluster for short, all the tenants in the failed cluster are regarded as independent entities, and the actual total quantity R(i) of the resources occupied by the tenant i in the failed cluster is equal to the sum of the usage quotas of the application resources in the tenant, as shown in FIG. 5.
2) among all the worker clusters in the normal working state, worker clusters which meet the following conditions are searched: available resources RA(i) of the tenant i in the worker cluster exceed the total quantity R(i) of the resources occupied by the tenant i of the failed cluster; RA(i)−R(i) is maximal in all the worker clusters that satisfy the above condition. This worker cluster is used as a target cluster for overall migration of all the applications in the tenant i of the failed cluster, that is, the applications are finally migrated towards the worker cluster, and the worker cluster is also called a migration-in worker cluster, and correspondingly, the failed worker cluster is called a migration-out worker cluster. Tenant overall failure migration is shown in FIG. 6.
3) If no worker cluster can satisfy RA(i)≥R(i), it indicates that all the worker clusters are not enough to accommodate all the applications of the tenant i as a whole; then, the failure migration solution is planned separately for each application in the tenant i of the failed cluster.
4) The applications of the tenant i are sorted in a descending order of the application priorities; the applications with the same priority are sorted according to an ascending order of required total resource quantities, the application with smaller resource consumption is given a higher priority in the order, and the application with larger resource consumption is given a lower priority in the order. The resource consumptions are compared according to the sequence of the storage, the CPU and the memory, and in the applications with the same storage requirements, the application with a low CPU requirement has a small total resource quantity; in the applications with the same storage and CPU requirements, the application with small memory occupation has a small total resource quantity.
5) From the sorted queue, the total resource occupation quantity Rapp(i, j) of each application j is calculated, and as shown in FIG. 7. A worker cluster satisfying the following conditions is searched in all the worker clusters in the normal worker state: the available resource RA(i) of the tenant i in the worker cluster exceeds the total resource occupation quantity Rapp(i, j) of the application j of the tenant i of the failed cluster; and RA(i)−Rapp(i, j) is largest among all the clusters that satisfy the above condition. This worker cluster is used as the target cluster for migrating the application j of the tenant i of the failed cluster, and the application j is deleted from the queue. The overall migration of the applications in the tenant is shown in FIG. 8.
6) If all the components of the application j of the tenant i of the failed cluster cannot be completely contained in a resource space of the tenant i of each of all the worker clusters in the normal worker state, failure migration of the application j is subdivided into failure migration to different worker clusters according to different components of the application j.
7) The total resource occupation quantity RappComp(i, j, k) of a component k of the application j in the tenant i of the failed cluster is calculated, and a cluster meeting the following conditions is searched in all the worker clusters in the normal worker state: the available resource RA(i) of the tenant i in the worker cluster exceeds the resource occupation quantity RappComp(i, j, k) of the component k of the application j of the tenant i of the failed cluster; and RA(i)−RappComp(i, j, k) is largest among all the worker clusters that satisfy the above condition. This worker cluster is used as a target cluster for migrating the component k of the application j of the tenant i of the failed cluster.
8) If all the components in the application j of the tenant i meet the migration condition, the application j is deleted from the queue; the next application is selected from the queue and the process jumps to the step 5). Completion of application migration by different components is shown in FIG. 9.

Step (7): optimizing, by the management cluster, the generated preliminary failure migration solution.

In the present embodiment, the principle of optimizing and adjusting the preliminary failure migration solution by the failure migration scheduling module is as follows.
1) When all the components of all the applications in the tenant meet the migration condition (the sorting queue is emptied), the method does not need solution optimization, and directly proceeds to step (8).
2) When there still are applications or application components in the sorting queue which do not meet the migration condition, the application j with the lowest priority is selected from the applications of the current tenant that already meet the migration condition, and for the components k thereof, if maxReplicas (maximum replicate number) of the component k is greater than 1, the replicate number of the component k is reduced by 1 from the preliminary failure migration solution, so as to save a part of resources, but the reduced value is not less than minReplicas (minimum replicate number), thereby reducing a number of occupied resources after the component is migrated, and the method jumps to the step 6) of the step (6). The preliminary failure migration solution is a failure migration solution created according to a default configuration strategy, for example, after an application component is migrated to a new worker cluster, 3 replicates are kept. MaxReplicas and minReplicas represent the maximum replicate number and the minimum replicate number respectively.
3) In order of application priority from low to high, attempts are continually made to reduce reducible replicate numbers of all the components in other applications of the current tenant that already meet the migration condition until the components that do not meet the migration conditions are incorporated into the failure migration solution.
4) If all the reducible replicate numbers have been reduced and there still exist application components which do not meet the migration condition in the queue, the application is marked as being incapable of realizing failure migration (providing information for generating a migration report), and other components which meet the migration conditions of the application are deleted from the solution (all the components of the application are migrated or are not migrated at all).

In the present embodiment, if the components of some applications in the preliminary failure migration solution cannot be migrated, that is, the resources are not enough, the number of replicates of the application components with lower priorities is reduced from the preliminary failure migration solution, so as to save some resources; then, check whether the residual resources are sufficient or not to ensure that the components which were previously unable to be migrated due to insufficient resources are included into a migration flow; if the resources are still not enough, some replicates are deleted in sequence, and the process is repeated; if the saved resources still cannot accommodate all of the components after all of the reducible replicates are removed, failure migration of these components cannot be realized.

Step (8): implementing, by the management cluster, failure migration according to the final failure migration solution.

In the present embodiment, the failure migration scheduling module implements failure migration according to the finally optimized failure migration solution generated in the above steps, and redeploys, in the destination cluster, all the applications and components in the failed cluster that can be migrated, thereby completing failure migration.

Step (9): after the failure migration is completed, generating, by the management cluster, a failure migration report.

In the present embodiment, after the migration of the tenants, the applications and the components is completed according to the failure migration solution, the failure migration scheduling module generates the failure migration report. Taking the tenant A as an example, the form and specific content of the failure migration report are as follows.

In the tenant A:

Successfully migrated application: the worker cluster in which the application is located after the failure migration (that is, the migration-in worker cluster), or the worker cluster in which each component is located, or the like.

Application that cannot be migrated: names and components of the applications that cannot be migrated.

In the present embodiment, under the multi-cluster environment constructed by the plurality of kubernetes clusters, the management cluster manages other worker clusters and senses health states of the worker clusters in real time; the tenant created by the management cluster occupies a part of the resource quota in each worker cluster. When sensing a failure of a certain worker cluster, the management cluster may automatically generate the failure migration solution according to the tenant application migration configuration information and the current state information of each worker cluster and implements migration, so that service stopping times of the applications can be reduced to the maximum extent in a multi-cluster and multi-tenant environment, and the utilization rate of the resources is effectively improved.

The present embodiment provides the multi-cluster application failure migration method and system supporting multiple tenants, and the multi-cluster environment formed by one kubernetes management cluster and the plurality of kubernetes worker clusters is constructed. In the multi-cluster environment, the user application is subordinate to the tenant of the worker cluster; when any worker cluster fails, the management cluster automatically generates the failure migration solution according to the state of the worker cluster, and migrates the application from the failed worker cluster to other non-failed worker clusters by taking the tenant, the application or the component as granularity according to the residual resource situation of the tenant, so that high reliability of the application is achieved, and the resource utilization rate is improved. The system is a software system including the multi-cluster state collection module, the failure migration scheduling module and the tenant management module, and not only supports migration of the application from one failed cluster to a plurality of normal clusters, but also supports failure migration of the application according to the tenant, so that resource measurement of failure migration is facilitated. Moreover, the migrating target cluster does not need to be specified in advance, the failure migration solution is automatically generated according to the brief configuration and cluster resource information, so that flexibility is high; meanwhile, the method also supports an idempotent principle, the method and the system support the failure of one worker cluster and the simultaneous failure or the sequential failure of a plurality of worker clusters, the processing solutions are the same, and special treatment is not needed. In addition, the method and the system also support migration of the application components to different worker clusters, and fragment resources in each worker cluster are fully utilized, so that the increase of a resource application quantity caused by overall application disaster recovery is avoided.

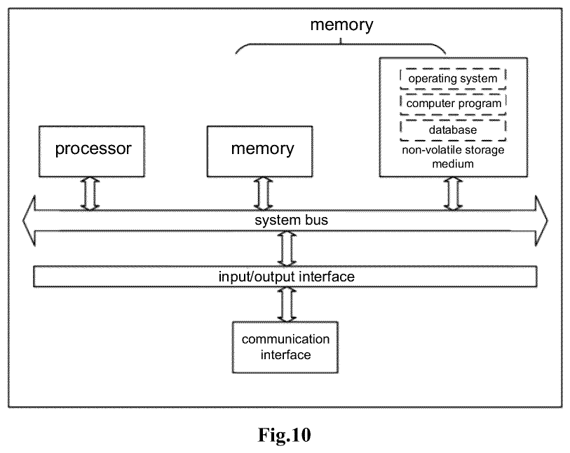

In an exemplary embodiment, there is provided a multi-cluster application failure migration system supporting multiple tenants, which may be a computer device, and the computer device may be a server or a terminal, an internal structure diagram of which may be shown in FIG. 10. The computer device includes a processor, a memory, an input/output (I/O) interface, and a communication interface. The processor, the memory, and the input/output interface are connected through a system bus, and the communication interface is connected to the system bus through the input/output interface. The processor of the computer device is configured to provide computing and control capabilities. The memory of the computer device includes a non-volatile storage medium and an internal memory. The non-volatile storage medium stores an operating system, computer programs, and a database. The internal memory provides an environment for running of the operating system and the computer programs in the non-volatile storage medium. The database of the computer device is configured to store related data of multi-cluster application failure migration supporting multiple tenants. The input/output interface of the computer device is configured to exchange information between the processor and an external device. The communication interface of the computer device is configured to be communicated with an external terminal through a network connection. The computer program is executed by the processor to implement a multi-cluster application failure migration method supporting multiple tenants.

Those skilled in the art will appreciate that the structure shown in FIG. 10 is only a block diagram of a part of the structure associated with the application solution and does not constitute a limitation on the computer device to which the application solution is applied, and a specific computer device may include more or fewer components than shown components, or combine certain components, or have a different arrangement of components.

It will be understood by those skilled in the art that all or part of the processes of the method according to the embodiments described above may be implemented by a computer program instructing related hardware, and the computer program may be stored in a non-volatile computer-readable storage medium, and when executed, may include the processes of the embodiments of the method described above. Any reference to memories, databases or other media used in the embodiments of the present application can include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, or the like. The volatile memory can include a random access memory (RAM), an external cache memory, or the like. By way of illustration and not limitation, the RAM can take many forms, such as a static random access memory (SRAM), a dynamic random access memory (DRAM), or the like.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the specification.

The specific examples are applied herein to state the principles and implementations of the application. The description of the embodiments above is only intended to assist in understanding the method according to the present application and core ideas thereof. However, persons skilled in the art could, based on the ideas in the application, make alterations to the specific implementations and application scope. In conclusion, the content of the present specification should not be construed as placing limitations on the present application.

1. A multi-cluster application failure migration method supporting multiple tenants, comprising:
creating a multi-cluster environment by using kubernetes application software; wherein the multi-cluster environment comprises a management cluster and a plurality of worker clusters, the management cluster is configured to manage each worker cluster, and the worker clusters are configured to deploy the tenants;
for each worker cluster in the multi-cluster environment, creating the tenants in the worker cluster; wherein each worker cluster comprises a plurality of tenants, and the tenants are used for resource isolation in a single worker cluster scenario and resource isolation across clusters in a multi-worker cluster scenario;
for each tenant, deploying an application in the tenant and configuring a failure migration strategy associated with the application; wherein the application comprises a plurality of components, the failure migration strategy comprises tenant information and application information, the application information comprises an application weight and application topology, the application weight is used for representing a priority of the application during failure migration, and the application topology comprises a maximum replicate number and a minimum replicate number of each component in the application after failure migration;
generating a resource quota information table according to the failure migration strategy and state information of the worker cluster; wherein the state information of the worker cluster comprises application deployment information of each tenant in the worker cluster, application resource occupation information and worker-cluster overall resource occupation information, and the resource quota information table comprises total resource information of each worker cluster, resource occupation information of each tenant, a maximum resource utilization value, an average resource occupation value and a worker cluster state; and
generating a failure migration solution according to the resource quota information table; wherein the failure migration solution is used for providing a technical guidance after a worker cluster fails, so as to facilitate the tenants, the applications and the components in the failed worker cluster which can be migrated to be migrated to other non-failed worker clusters and redeployed.

2. The multi-cluster application failure migration method supporting multiple tenants according to claim 1, wherein a multi-cluster state collection module, a failure migration scheduling module, and a tenant management module are arranged in the management cluster;
wherein, the multi-cluster state collection module is configured to configure an access authorization certificate of each worker cluster in the management cluster, and acquire the state information and the resource information of each worker cluster through APIServer of each worker cluster;
the failure migration scheduling module is configured to acquire the state information and the resource information of each worker cluster from the multi-cluster state collection module, generate the failure migration solution in real time according to the failure migration strategy and execute failure migration of the application;
the tenant management module is configured to manage the tenant information in each worker cluster.

3. The multi-cluster application failure migration method supporting multiple tenants according to claim 1, wherein for each worker cluster in the multi-cluster environment, creating the tenants in the worker cluster specifically comprises:
creating corresponding tenant in each worker cluster according to tenant configuration information; wherein the tenant configuration information comprises name of the tenant, a total resource quota and a sub-quota, the total resource quota representing a total CPU quota, a total memory quota and a total storage quota occupied by the tenant in the whole multi-cluster environment, and the sub-quota representing a CPU quota, a memory quota and a storage quota occupied by the tenant in each worker cluster; and
generating an identification code for each tenant, the identification code being used for identifying identity information of the tenant.

4. The multi-cluster application failure migration method supporting multiple tenants according to claim 3, wherein the identification code is a UUID.

5. The multi-cluster application failure migration method supporting multiple tenants according to claim 1, wherein for each tenant, deploying an application in the tenant and configuring a failure migration strategy associated with the application specifically comprises:
deploying the application for each tenant by adopting an automatic deployment tool to obtain the tenant information and the application information corresponding to each tenant; and
determining the failure migration strategy according to the tenant information and the application information corresponding to each tenant.

6. The multi-cluster application failure migration method supporting multiple tenants according to claim 5, wherein the automatic deployment tool is Argocd.

7. The multi-cluster application failure migration method supporting multiple tenants according to claim 1, wherein generating a failure migration solution according to the resource quota information table specifically comprises:
generating a preliminary failure migration solution according to the resource quota information table; and
optimizing the preliminary failure migration solution to obtain an optimized failure migration solution; the optimized failure migration solution being used as the finally generated failure migration solution.

8. The multi-cluster application failure migration method supporting multiple tenants according to claim 7, wherein optimizing the preliminary failure migration solution to obtain an optimized failure migration solution specifically comprises:
determining the application with the minimum application weight from all the applications of the tenant meeting a migration condition according to the application weights corresponding to respective applications;
for components in the application with the minimum application weight, when the maximum replicate number of a component is greater than 1, reducing a replicate number of the component by 1 from the preliminary failure migration solution; in order of application priority from low to high, reducing the reducible replicate numbers of all the components in other applications of the current tenant that already meet the migration condition in this replicate number reduction mode, until the component which does not meet the migration condition is incorporated into the preliminary failure migration solution; and
when the application and the component thereof which do not meet the migration condition still exist after all the reducible replicate numbers are reduced completely, marking the application and the component thereof which do not meet the migration condition as a type which cannot be migrated, and deleting other components of this application meeting the migration condition from the preliminary failure migration solution to obtain the optimized failure migration solution.

9. The multi-cluster application failure migration method supporting multiple tenants according to claim 7, wherein after the step of optimizing the preliminary failure migration solution to obtain an optimized failure migration solution, the multi-cluster application failure migration method supporting multiple tenants further comprises:
after a worker cluster fails, performing failure migration on the tenants, the applications and the components in the failed worker cluster which can be migrated according to the optimized failure migration solution, and generating a failure migration report; wherein the failure migration report comprises migration-in worker cluster information and migration-out worker cluster information of the successfully migrated applications for each tenant in the failed worker cluster, and names and the components of the applications which cannot be migrated.

10. A multi-cluster application failure migration system supporting multiple tenants, comprising: a memory, a processor and a computer program stored on the memory and capable of running on the processor, wherein the processor executes the computer program to implement the following steps of a multi-cluster application failure migration method supporting multiple tenants:
creating a multi-cluster environment by using kubernetes application software; wherein the multi-cluster environment comprises a management cluster and a plurality of worker clusters, the management cluster is configured to manage each worker cluster, and the worker clusters are configured to deploy the tenants;
for each worker cluster in the multi-cluster environment, creating the tenants in the worker cluster; wherein each worker cluster comprises a plurality of tenants, and the tenants are used for resource isolation in a single worker cluster scenario and resource isolation across clusters in a multi-worker cluster scenario;
for each tenant, deploying an application in the tenant and configuring a failure migration strategy associated with the application; wherein the application comprises a plurality of components, the failure migration strategy comprises tenant information and application information, the application information comprises an application weight and application topology, the application weight is used for representing a priority of the application during failure migration, and the application topology comprises a maximum replicate number and a minimum replicate number of each component in the application after failure migration;
generating a resource quota information table according to the failure migration strategy and state information of the worker cluster; wherein the state information of the worker cluster comprises application deployment information of each tenant in the worker cluster, application resource occupation information and worker-cluster overall resource occupation information, and the resource quota information table comprises total resource information of each worker cluster, resource occupation information of each tenant, a maximum resource utilization value, an average resource occupation value and a worker cluster state; and
generating a failure migration solution according to the resource quota information table; wherein the failure migration solution is used for providing a technical guidance after a worker cluster fails, so as to facilitate the tenants, the applications and the components in the failed worker cluster which can be migrated to be migrated to other non-failed worker clusters and redeployed.

11. The multi-cluster application failure migration system supporting multiple tenants according to claim 10, wherein a multi-cluster state collection module, a failure migration scheduling module, and a tenant management module are arranged in the management cluster;
wherein, the multi-cluster state collection module is configured to configure an access authorization certificate of each worker cluster in the management cluster, and acquire the state information and the resource information of each worker cluster through APIServer of each worker cluster;
the failure migration scheduling module is configured to acquire the state information and the resource information of each worker cluster from the multi-cluster state collection module, generate the failure migration solution in real time according to the failure migration strategy and execute failure migration of the application;
the tenant management module is configured to manage the tenant information in each worker cluster.

12. The multi-cluster application failure migration system supporting multiple tenants according to claim 10, wherein for each worker cluster in the multi-cluster environment, creating the tenants in the worker cluster specifically comprises:
creating corresponding tenant in each worker cluster according to tenant configuration information; wherein the tenant configuration information comprises name of the tenant, a total resource quota and a sub-quota, the total resource quota representing a total CPU quota, a total memory quota and a total storage quota occupied by the tenant in the whole multi-cluster environment, and the sub-quota representing a CPU quota, a memory quota and a storage quota occupied by the tenant in each worker cluster; and
generating an identification code for each tenant, the identification code being used for identifying identity information of the tenant.

13. The multi-cluster application failure migration system supporting multiple tenants according to claim 3, wherein the identification code is a UUID.

14. The multi-cluster application failure migration system supporting multiple tenants according to claim 1, wherein for each tenant, deploying an application in the tenant and configuring a failure migration strategy associated with the application specifically comprises:
deploying the application for each tenant by adopting an automatic deployment tool to obtain the tenant information and the application information corresponding to each tenant; and
determining the failure migration strategy according to the tenant information and the application information corresponding to each tenant.

15. The multi-cluster application failure migration system supporting multiple tenants according to claim 5, wherein the automatic deployment tool is Argocd.

16. The multi-cluster application failure migration system supporting multiple tenants according to claim 10, wherein generating a failure migration solution according to the resource quota information table specifically comprises:
generating a preliminary failure migration solution according to the resource quota information table; and
optimizing the preliminary failure migration solution to obtain an optimized failure migration solution; the optimized failure migration solution being used as the finally generated failure migration solution.

17. The multi-cluster application failure migration system supporting multiple tenants according to claim 16, wherein optimizing the preliminary failure migration solution to obtain an optimized failure migration solution specifically comprises:
determining the application with the minimum application weight from all the applications of the tenant meeting a migration condition according to the application weights corresponding to respective applications;
for components in the application with the minimum application weight, when the maximum replicate number of a component is greater than 1, reducing a replicate number of the component by 1 from the preliminary failure migration solution; in order of application priority from low to high, reducing the reducible replicate numbers of all the components in other applications of the current tenant that already meet the migration condition in this replicate number reduction mode, until the component which does not meet the migration condition is incorporated into the preliminary failure migration solution; and
when the application and the component thereof which do not meet the migration condition still exist after all the reducible replicate numbers are reduced completely, marking the application and the component thereof which do not meet the migration condition as a type which cannot be migrated, and deleting other components of this application meeting the migration condition from the preliminary failure migration solution to obtain the optimized failure migration solution.

18. The multi-cluster application failure migration system supporting multiple tenants according to claim 16, wherein after the step of optimizing the preliminary failure migration solution to obtain an optimized failure migration solution, the multi-cluster application failure migration method supporting multiple tenants further comprises:
after a worker cluster fails, performing failure migration on the tenants, the applications and the components in the failed worker cluster which can be migrated according to the optimized failure migration solution, and generating a failure migration report; wherein the failure migration report comprises migration-in worker cluster information and migration-out worker cluster information of the successfully migrated applications for each tenant in the failed worker cluster, and names and the components of the applications which cannot be migrated.
